(19) United States
(12) Patent Application Publication
(10) Pub. No.: US 2018/0161850 A1
(43) Pub. Date: Jun. 14, 2018

(54) SINGLE-SIDED JOINING MACHINE

(71) Applicant: GM GLOBAL TECHNOLOGY OPERATIONS LLC, DETROIT, MI (US)

(72) Inventor: Dalong GAO, Rochester, MI (US)

(21) Appl. No.: 15/372,530

(22) Filed: Dec. 8, 2016

(51) Int. Cl. B21J 15/02; B23K 20/12

(52) U.S. Cl. CPC B21J 15/027; B23K 20/1295

(57) ABSTRACT

A joining machine includes a robotic arm having a distal end, a tool configured for driving a fastener into a workpiece, and a compensation device mounted between the distal end of the robotic arm and a first end of the tool. The compensation device is configured to move the tool in at least one of a linear and a rotational direction to compensate for deflection of the robotic arm when the fastener is driven into the workpiece.

### FIELD

The present disclosure relates to a single-sided joining machine design.

### INTRODUCTION

The statements in this section merely provide background information related to the present disclosure and may not constitute prior art.

Friction plunge fastening or friction-stir fastening is a process for joining parts with a rotating fastener. In particular, a fastener of a temperature stable material having an enlarged head with slots or other configurations is drivingly fit with a separate rotatable driver of an installation tool for accommodating the torque as well as the axial load of the tool. The fastener further includes a shank portion axially depending from the head to frictionally engage and progressively heat and bore into the parts being joined. Frictional heat is generated as the rotating fastener physically works the material of the parts to create a plasticized region of material in the overlap surrounding the rotating shank. As the fastener rotation and frictional heating terminates, the softened or plasticized material of the parts cools and solidifies around the fastener shank thereby joining the parts. In some instances, diffusion bonding may take place between the outer surfaces of the fastener shank and the material of the joint when the plasticization points of the interfaces of the rivet and that of the parts being connected are metallurgically compatible.

### SUMMARY

A joining machine includes a robotic arm having a distal end, a tool configured for driving a fastener into a workpiece, and a compensation device mounted between the distal end of the robotic arm and a first end of the tool. The compensation device is configured to move the tool in at least one of a linear and a rotational direction to compensate for deflection of the robotic arm when the fastener is driven into the workpiece.

A single-sided joining machine includes a robotic arm having a distal end, a friction-stir fastening tool configured for driving a fastener into a workpiece, and a compensation device having a plate pivotally secured to the distal end of the robotic arm and fixedly secured to an upper surface of the friction-stir fastening tool. The plate is pivotally moved toward and away from the distal end of the robotic arm to compensate for deflection of the robotic arm when the fastener is driven into the workpiece.

A single-sided joining machine includes a robotic arm having a distal end, a friction-stir fastening tool configured for driving a fastener into a workpiece, and a compensation device having a plate fixedly secured to the distal end of the robotic arm. The friction-stir fastening tool is linearly movable along the plate to compensate for deflection of the robotic arm when the fastener is driven into the workpiece.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic view of an exemplary joining machine having a compensation device according to the present disclosure;

FIG. 2A is a schematic view of a conventional joining machine prior to a fastening process;

FIG. 2B is a schematic view of the conventional joining machine of FIG. 2A during the fastening process;

FIG. 2C is a schematic view of the conventional joining machine of FIG. 2A subsequent the fastening process;

FIG. 3A is a schematic view of an exemplary joining machine having a compensation device prior to a fastening process;

FIG. 3B is a schematic view of the exemplary joining machine having the compensation device during the fastening process;

FIG. 3C is a schematic view of the exemplary joining machine having the compensation device subsequent the fastening process;

FIG. 4 is a schematic view of another exemplary joining machine having a single degree of freedom compensation device according to the present disclosure;

FIG. 5 is a schematic view of another exemplary joining machine having a single degree of freedom compensation device according to the present disclosure;

FIG. 6 is a schematic view of another exemplary joining machine having a single degree of freedom compensation device according to the present disclosure;

FIG. 7 is a schematic view of another exemplary joining machine having a two degrees of freedom compensation device according to the present disclosure;

FIG. 8 is a schematic view of another exemplary joining machine having a two degrees of freedom compensation device according to the present disclosure; and

FIG. 9 is a schematic view of another exemplary joining machine having a two degrees of freedom compensation device according to the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features. Further, directions such as “top,” “side,” “back”, “lower,” and “upper” are used for purposes of explanation and are not intended to require specific orientations unless otherwise stated. These directions are merely provided as a frame of reference with respect to the examples provided, but could differ in alternate applications.

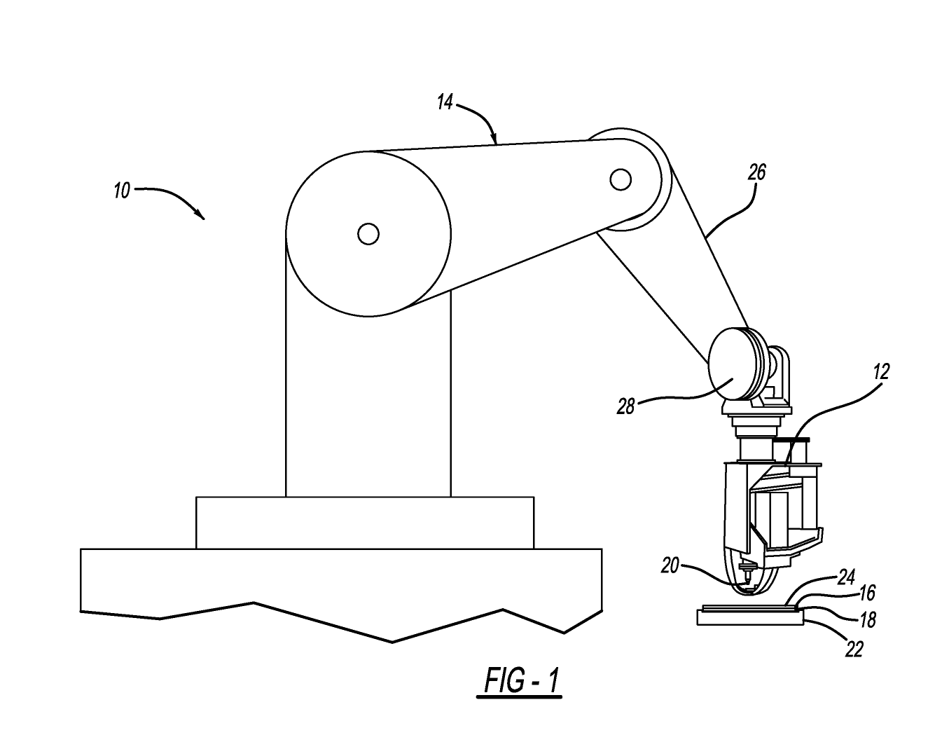

The present disclosure describes an exemplary single-sided joining machine adapted to form a welded joint using a friction stir fastening process. With reference to the drawings, wherein like reference numbers refer to like components, an exemplary single-sided joining machine 10 includes a friction stir tool 12 secured to a tool positioning system 14. The friction stir tools of the present invention may be utilized with various styles of spot welding devices (e.g., C gun type, X gun type, pogo type). The single-sided joining machine 10 can be used to join first and second workpieces 16, 18 with a fastener 20, as shown in FIG. 1. The fastener 20 is configured to mechanically fasten the first and second workpieces 16, 18 when subjected to a rotating driving force, such as may be achieved by the friction stir tool 12 acting on the fastener 20. The first and second workpieces 16, 18 may be arranged upon a nest 22 for support during the joining process. In some embodiments, however, the first and second workpieces 16, 18 may have enough inherent strength to support the process without the need for the nest 22. The high speed spin of the fastener 20 generates heat at the workpieces 16, 18, allowing a shank of the fastener 20 to penetrate the workpieces 16, 18 under the force of the friction stir tool 12. Furthermore, the shank is configured to deform to create a mechanical joint. The whole process does not require a lead hole for the fastener 20 in the workpieces 16, 18.

The exemplary single-sided joining machine 10 including the tool positioning system 14 moves the friction stir tool 12 in a direction adjacent to an upper surface 24 of the workpieces 16, 18 according to a fastening or welding schedule. In order to perform this movement, the tool positioning system 14 further includes a robotic arm 26 having an end effector 28. The robotic arm 26 may be separated into multiple sections allowing for a greater reach and angular position for the tool positioning system 14. Because the robotic arm 26 and the end effector 28 include a plurality of articulated joints arranged in series, there are intrinsic compliance and positioning tolerances. These compliance and positioning tolerances are more difficult to maintain initially during the fastening operation and can result in deflection of the friction stir tool 12. The further the robotic arm 26 moves the end effector 28 and friction stir tool 12 from the center of mass of the tool positioning system 14, the more difficult it becomes to maintain the initial envelope of accuracy for the fastener 20.

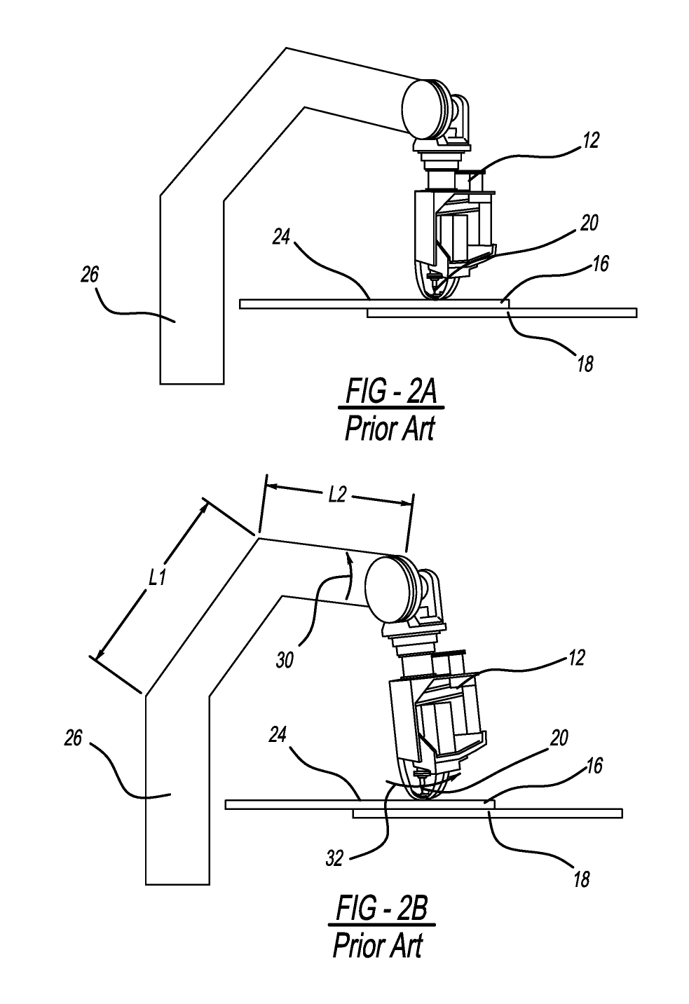

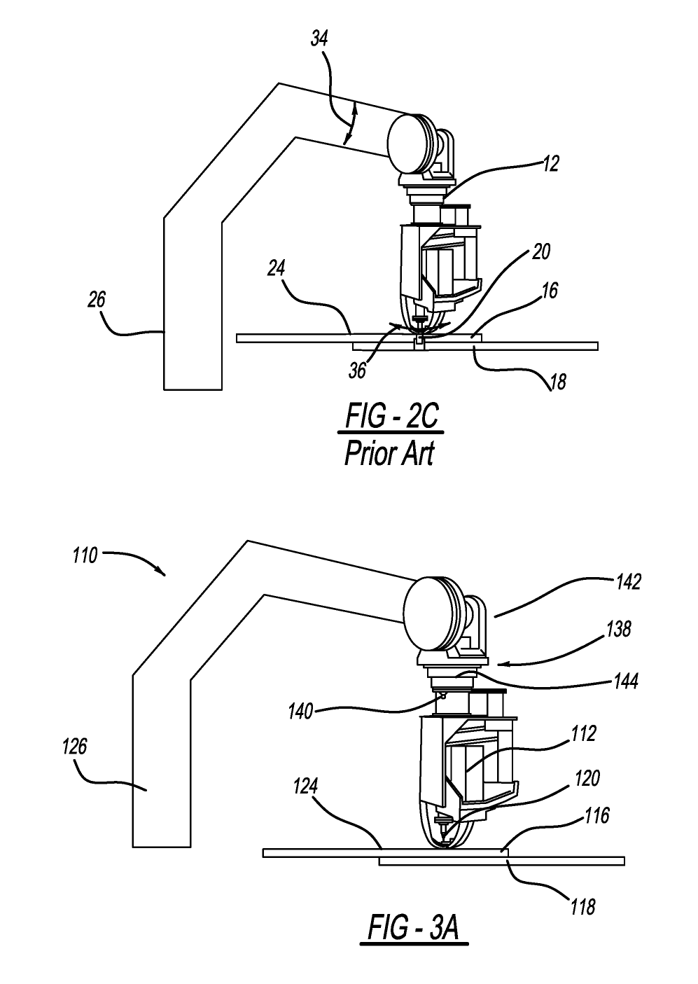

With respect to FIG. 2A, the robotic arm 26 and friction stir tool 12 are depicted schematically at a predetermined location on the upper surface 24 of the workpieces 16, 18 representative of an insertion point for the fastener 20. Before the fastener 20 begins insertion, the friction stir tool 12 approaches the upper surface 24 perpendicular to the workpieces 16, 18.

In FIG. 2B, the friction stir tool 12 begins rotating the fastener 20 and feeds it towards the upper surface 24 of the workpieces 16, 18. However, the material at the upper surface 24 is hardened and causes the robotic arm 26 to rotationally deflect in the direction of arrow 30. The vertical deflection of the robotic arm 26 can be defined from the equation (1) and the horizontal movement (e.g., walk) of the robotic arm 26 can be defined from the equation (2):

$$\begin{matrix}\frac{{P}_{2} {L}_{2}^{3}}{3 {E}_{2} {I}_{2}} cos {θ}_{2} - {L}_{3} \frac{{P}_{2} {L}_{2}^{2}}{3 {E}_{2} {I}_{2}} cos ( {θ}_{2} + {θ}_{3} ) - \frac{{P}_{3} {L}_{3}^{3}}{3 {E}_{3} {I}_{3}} cos ( {θ}_{2} + {θ}_{3} ) & ( 1 ) \\ - \frac{{P}_{2} {L}_{2}^{3}}{3 {E}_{2} {I}_{2}} sin {θ}_{2} + {L}_{3} \frac{{P}_{2} {L}_{2}^{2}}{3 {E}_{2} {I}_{2}} sin ( {θ}_{2} + {θ}_{3} ) + \frac{{P}_{3} {L}_{3}^{3}}{3 {E}_{3} {I}_{3}} sin ( {θ}_{2} + {θ}_{3} ) & ( 2 )\end{matrix}$$

where,
Pₓ is the load at the end of the robotic arm x
Lₓ is the length of the robotic arm x
Eₓ is the modulus of elasticity of the robotic arm x
Iₓ is the moment of inertia of the robotic arm x about its neutral axis
θₓ is the rotation angle of the robotic arm x as defined by Denavit-Hartenberg convention

As the robotic arm 26 deflects, the friction stir tool 12 is similarly moved angularly away from the upper surface 24, as shown by arrow 32. The deflection experienced results in the fastener 20 creating a larger heated area than necessary. The increased size of the heated area, in turn, may result in a longer cycle time and a higher tool utilization (e.g., greater tool wear than optimal). In one example, a fastener having a 4.76 mm diameter is estimated to have a horizontal movement (i.e., sidewalk) of 2.4 mm where vertical deflection is 4 mm.

As the material of the workpieces 16, 18 softens, the fastener 20 punches in through the upper surface 24 and the robotic arm 26 springs back, as best shown in FIG. 2C. The springback experienced by the robotic arm 26 (e.g., represented by arrow 34) and friction stir tool 12 results in a vibration motion at the fastener 20 as it penetrates the workpieces 16, 18 (e.g., represented by arrow 36). As should be understood, the primary motion experienced by the tip of the fastener 20 due to the described deflection can be characterized as a side-to-side motion (i.e., horizontal), while the secondary motion experienced by the tip of the fastener 20 can be characterized as rotational motion away from its feed direction.

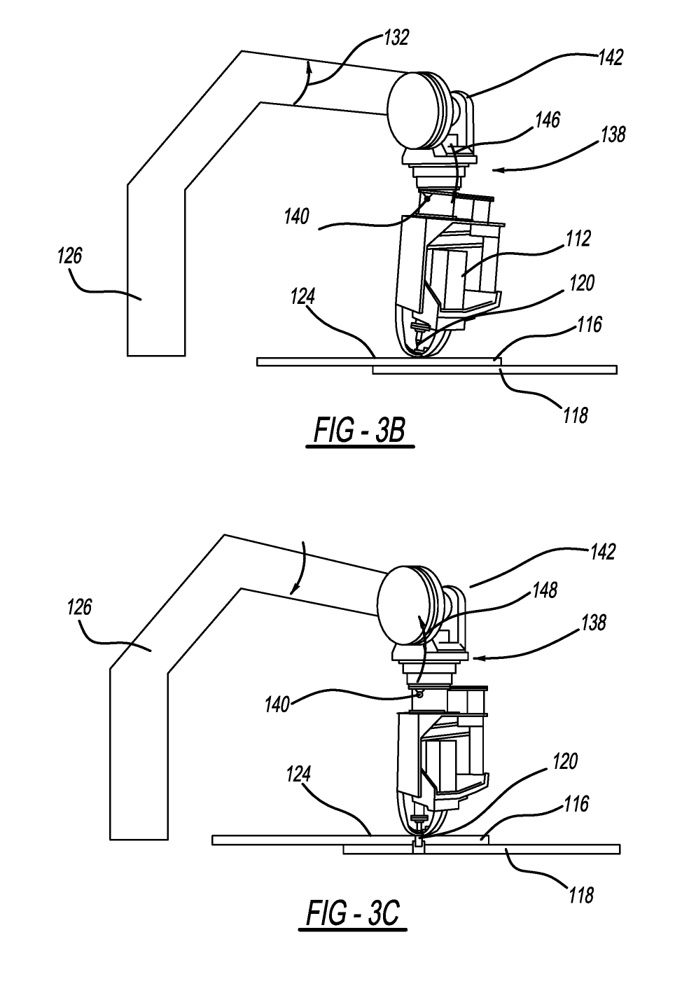

With reference to FIGS. 3A, 3B, and 3C, a schematic view of an exemplary single-sided joining machine 110 having a compensation device 138 is shown. The compensation device 138 may reduce or completely eliminate the deformation of the mounting structure during a drilling operation, as will be described in further detail below. Initial operation of the single-sided joining machine 110 is substantially similar to that of the single-sided joining machine 10, but for timing of fastener feed rate.

In particular and with respect to FIG. 3A, a friction stir tool 112 is moved by a robotic arm 126 to a predetermined location adjacent an upper surface 124 of a pair of workpieces to be joined 116, 118, representative of an insertion point for the fastener 120. The compensation device 138 may have any configuration, but in one example is presented as a plate 140 hingedly secured to the robotic arm 126 at a distal end 142 thereof. The plate 140 may also be secured to an upper surface 144 of the friction stir tool 112, such that the robotic arm 126 may be rotated in a first direction (e.g., direction of rotational arrow 130 shown in FIG. 3B) and the friction stir tool 112 may be rotated in a second, opposing direction (e.g., direction of rotational arrow 142 shown in FIG. 3B) concurrently. Before the fastener 120 begins feeding, the friction stir tool 112 remains in contact with the upper surface 124 perpendicular to the workpieces 116, 118. The friction stir tool 112 begins rotation without advancement into the upper surface 124, thereby allowing the material to soften in a predetermined zone defined by the shank of the fastener 120. As there is a minimum pressure between the tip of the fastener 120 and the upper surface 124, there may only be minimal heat generated.

Referring now to FIG. 3B, the plate 140 of the compensation device 138 may begin to rotate away from the distal end 142 of the robotic arm 126 (e.g., in the direction of arrow 146). In this way, feed pressure on the upper surface 124 is presented primarily by the pivoting movement of the plate 140 away from the robotic arm 126. At the same time, the friction stir tool 112 may feed the fastener 120 into the workpiece materials 116, 118. The rotational action of the friction stir tool 112 along with the pivoting movement of the compensation device 138 and the feeding of the fastener 120 causes friction on the upper surface 124 of the workpieces 116, 118. In the exemplary embodiment described above (e.g., 4.76 mm diameter fastener having a horizontal movement of 2.4 mm when vertical deflection or feed is 4 mm), and assuming a 340 mm lever, the fastener 120 motion into the workpiece material caused by the rotation of the plate 140 of the compensation device 138 will be 1.2 mm, while the fastener feed is 2.8 mm in order to eliminate the horizontal movement. While the distal end 142 of the robotic arm 126 still deflects in the direction shown by arrow 132, the deflection does not result in any side-to-side motion (i.e., horizontal) at the fastener 120.

With reference now to FIG. 3C, as the material of the workpieces 116, 118 softens, the fastener 120 may gradually punch in through the upper surface 124. As the robotic arm 126 springs back, the plate 140 of the compensation device 138 may rotate counterclockwise back towards its initial position with respect to the distal end 142 of the robotic arm 126 (e.g., in the direction of arrow 148). This movement could reduce or eliminate any vibration motion that would otherwise be experienced by the fastener 120.

While the compensation device 138 is described as operating with a calculated or preset angular motion, it is also contemplated to utilize a closed loop system including sensor and/or feedback control to provide the appropriate tilt angle. In particular, sensors (e.g., load cell, infrared, vision based) can be added to the system to detect the horizontal movement of the fastener 120 and the time when the fastener 120 begins penetrating the upper surface 124 of the workpieces 116, 118 (e.g., time of material softening). Angular control of the compensation device 138 can then be utilized to combat any side-to-side motion (i.e., horizontal) or rotational motion of the fastener 120.

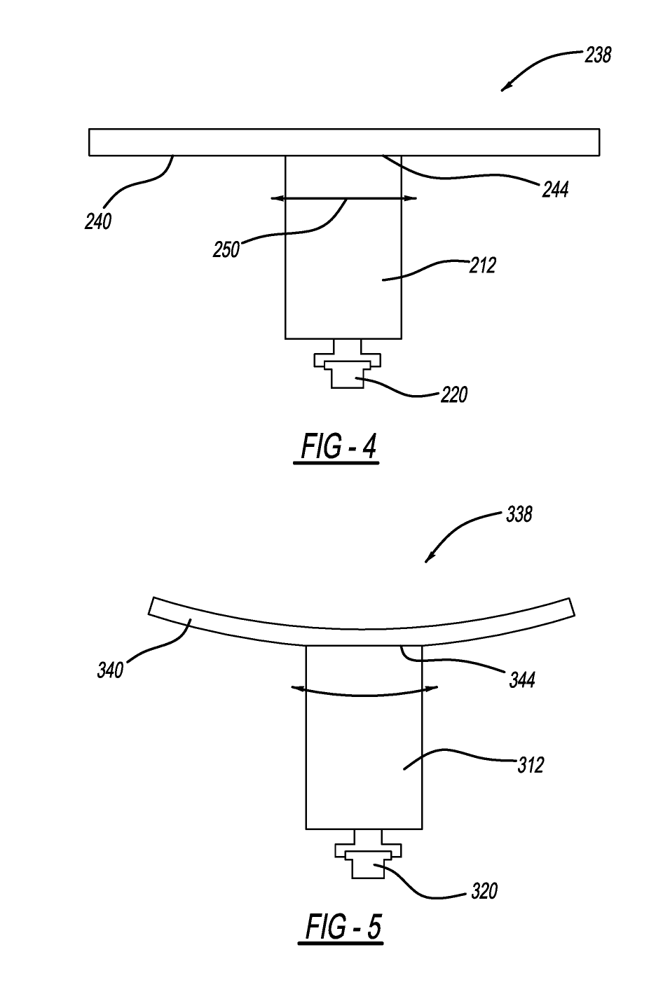

Referring now to FIG. 4, a schematic view of an alternate compensation device 238 secured to an upper surface 244 of a friction stir tool 212 is shown. The compensation device 238 incorporates a single degree of freedom mechanism to specifically remove the primary side-to-side motion (i.e., horizontal) of the fastener 220. Operation of the single-sided joining machine (not shown) is substantially similar to that of the single-sided joining machine 10; however, during operation the friction stir tool 212 may move linearly (e.g., in the direction of arrow 250) along a plate 240 of the compensation device 238 to counteract the side-to-side motion (i.e., horizontal) of the fastener 220.

With reference now to FIG. 5, a schematic view of another alternate compensation device 338 secured to an upper surface 344 of a friction stir tool 312 is shown. The compensation device 338 is substantially similar to the compensation device 238, but for the curvature of a plate 340 of the compensation device 338. By curving the plate 340, the compensation device 338 incorporates a single degree of freedom mechanism for removing the primary side-to-side motion (i.e., horizontal) and also for reducing the rotational motion of the fastener 320.

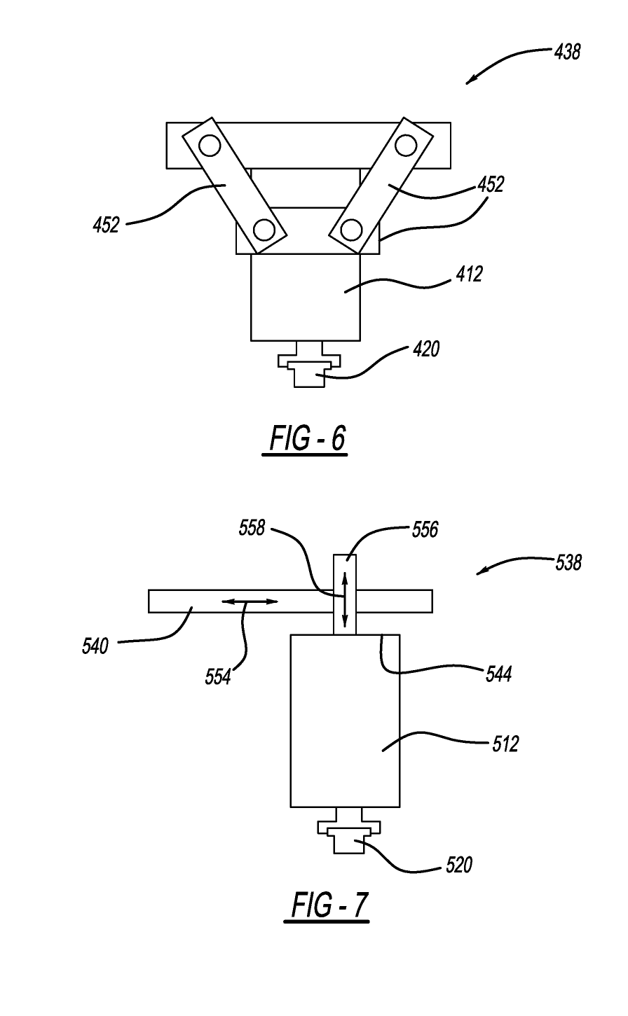

Referring now to FIG. 6, a schematic view of another alternate compensation device 438 secured to a friction stir tool 412 is shown. Like the compensation device 338, the compensation device 438 incorporates a single degree of freedom mechanism to remove the primary side-to-side motion (i.e., horizontal) and to reduce the rotational motion of the fastener 420. In order to accomplish this goal, however, the compensation device 438 incorporates a plurality of linkages 452. The linkages 452 may mount directly to the robotic arm (not shown) in order to allow movement of the friction stir tool 412 in both angular and rotational directions.

With reference now to FIG. 7, a schematic view of yet another alternate compensation device 538 secured to an upper surface 544 of a friction stir tool 512 is shown. The compensation device 538 incorporates a two degrees of freedom mechanism to combat the side-to-side motion (i.e., horizontal) and/or rotational motion of the fastener 520. Operation of the single-sided joining machine (not shown) is substantially similar to that of the single-sided joining machine 10; however, the friction stir tool 512 may be movable through a prismatic or revolute joint (e.g., PP, RP) with the movement performed in series or parallel. During operation, the friction stir tool 512 may be moved horizontally along the plate 540 (e.g., in the direction of arrow 554) and vertically along the plate 556 (e.g., in the direction of arrow 558) to counteract the side-to-side motion (i.e., horizontal) and the rotational motion of the fastener 520.

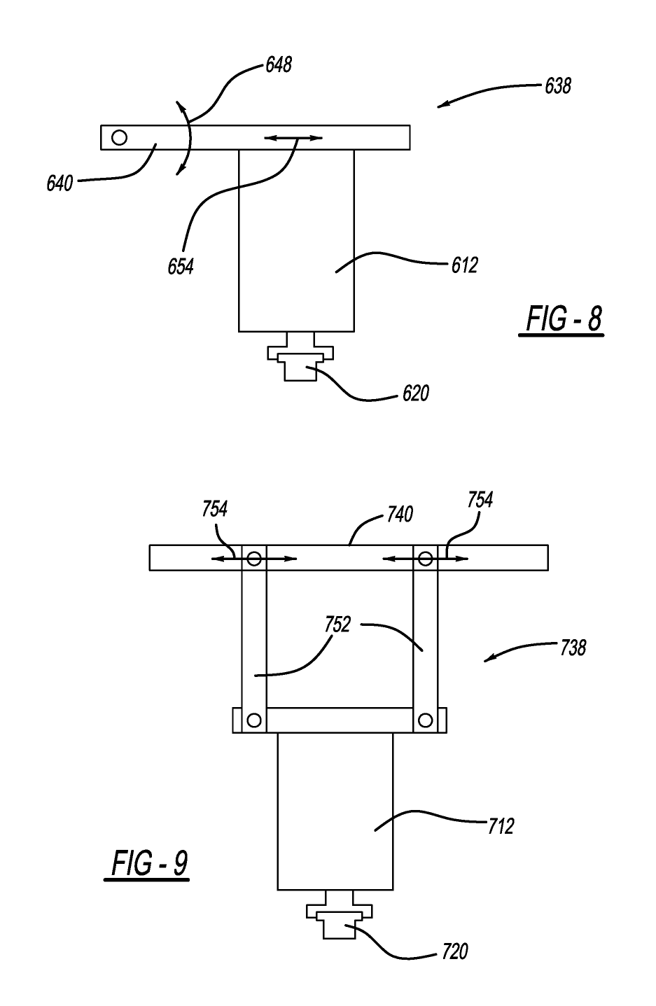

Referring now to FIG. 8, a schematic view of another alternate compensation device 638 secured to a friction stir tool 612 is shown. Like the compensation device 538, the compensation device 638 incorporates a two degrees of freedom mechanism to combat the side-to-side motion (i.e., horizontal) and/or rotational motion of the fastener 620. In order to accomplish this goal, the compensation device 638 incorporates a rotational plate 640 (e.g., rotatable in the direction of arrow 648). Furthermore, the friction stir tool 612 may be moved horizontally along the plate 640 (e.g., in the direction of arrow 654) to counteract the side-to-side motion (i.e., horizontal) of the fastener 620.

With reference now to FIG. 9, a schematic view of another alternate compensation device 738 secured to a friction stir tool 712 is shown. Like the compensation device 638, the compensation device 738 incorporates a two degrees of freedom mechanism to remove the primary side-to-side motion (i.e., horizontal) and/or rotational motion of the fastener 720. In order to accomplish this goal, however, the compensation device 738 incorporates a plurality of linkages 752 rotationally secured to a plate 740. The linkages 752 may mount directly to the plate 740 in order to allow movement of the friction stir tool 712 in both angular and rotational directions. Furthermore, the friction stir tool 712 may be moved horizontally along the plate 740 (e.g., in the direction of arrows 754) to counteract the side-to-side motion (i.e., horizontal) of the fastener 720.

Embodiments of the present disclosure are described herein. This description is merely exemplary in nature and, thus, variations that do not depart from the gist of the disclosure are intended to be within the scope of the disclosure. For example, actuation of the various compensation devices can be accomplished through various devices, such as through a pneumatic or hydraulic device, or through a direct drive, lead screw, or linkage. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for various applications. Various combinations and modifications of the features consistent with the teachings of this disclosure, however, could be desired for particular applications or implementations.

What is claimed is:

1. A joining machine comprising:
a robotic arm having a distal end;
a tool configured for driving a fastener into a workpiece; and
a compensation device mounted between the distal end of the robotic arm and a first end of the tool, wherein the compensation device is configured to move the tool in at least one of a linear and a rotational direction to compensate for deflection of the robotic arm when the fastener is driven into the workpiece.

2. The joining machine of claim 1, wherein the compensation device further includes a plate pivotally secured to the distal end of the robotic arm.

3. The joining machine of claim 2, wherein the plate rotates toward and away from an initial position with respect to the distal end of the robotic arm in order to obviate vibratory motion of the tool.

4. The joining machine of claim 1, further comprising a sensor for providing feedback regarding position of the fastener with respect to the workpiece.

5. The joining machine of claim 1, wherein motion of the compensation device is provided by one of a pneumatic device, a hydraulic device, a direct drive, a lead screw, and a linkage system.

6. The joining machine of claim 1, wherein the compensation device is a single degree of freedom system.

7. The joining machine of claim 6, wherein the tool is movable linearly along a flat plate of the compensation device.

8. The joining machine of claim 6, wherein the tool is movable along a curved plate of the compensation device.

9. The joining machine of claim 6, wherein the compensation device further includes a plurality of linkages.

10. The joining machine of claim 1, wherein the compensation device is a two degrees of freedom system.

11. The joining machine of claim 10, wherein the tool is movable linearly along a flat plate and perpendicularly with respect to the flat plate of the compensation device.

12. The joining machine of claim 10, wherein the compensation device further includes a plate pivotally secured to the distal end of the robotic arm, and wherein the tool is movable linearly along the plate of the compensation device.

13. The joining machine of claim 10, wherein the compensation device further includes a plurality of linkages.

14. A single-sided joining machine comprising:
a robotic arm having a distal end;
a friction-stir fastening tool configured for driving a fastener into a workpiece; and
a compensation device having a plate pivotally secured to the distal end of the robotic arm and fixedly secured to an upper surface of the friction-stir fastening tool, wherein the plate is pivotally moved toward and away from the distal end of the robotic arm to compensate for deflection of the robotic arm when the fastener is driven into the workpiece.

15. The single-sided joining machine of claim 14, further comprising a sensor for providing feedback regarding position of the fastener with respect to the workpiece.

16. The single-sided joining machine of claim 14, wherein motion of the compensation device is provided by one of a pneumatic device, a hydraulic device, a direct drive, a lead screw, and a linkage system.

17. The single-sided joining machine of claim 14, wherein the compensation device is a two degrees of freedom system.

18. The single-sided joining machine of claim 17, wherein the tool is movable linearly along the plate of the compensation device.

19. A single-sided joining machine comprising:
a robotic arm having a distal end;
a friction-stir fastening tool configured for driving a fastener into a workpiece; and
a compensation device having a plate fixedly secured to the distal end of the robotic arm, wherein the friction-stir fastening tool is linearly movable along the plate to compensate for deflection of the robotic arm when the fastener is driven into the workpiece.

20. The single-sided joining machine of claim 19, further comprising a sensor for providing feedback regarding position of the fastener with respect to the workpiece.
